(19) United States
(12) Patent Application Publication
(10) Pub. No.: US 2004/0201183 A1
(43) Pub. Date: Oct. 14, 2004

(54) Surgical drill chuck

(76) Inventor: Charles H. Burdette, Woodruff, SC (US)

Correspondence Address: MCNAIR LAW FIRM, PA, P.O. BOX 10827, GREENVILLE, SC, 29603-0827, US

(21) Appl. No.: 10/603,915

(22) Filed: Jun. 25, 2003

Related U.S. Application Data
(60) Provisional application No. 60/461,123, filed on Apr. 8, 2003.

(51) Int. Cl. B23B 31/12; B23B 5/34; B23B 5/22; B25G 3/02

(52) U.S. Cl. 279/62

(57) ABSTRACT

A surgical drill chuck comprising a main body of elongated cylindrical construction having intersecting main body end and main body side surfaces. A plurality of movable jaws of elongated cylindrical construction carried by the main body having intersecting jaw end and jaw side surfaces. A sleeve of elongated cylindrical construction carried circumferentially on the main body being operatively associated with the jaws for extending and retracting the jaws when the sleeve is rotated. The sleeve having intersecting sleeve end and sleeve side surfaces. Radiused corners provided at the intersection of the main body end and main body side surfaces, jaw end and jaw side surfaces, and sleeve end and sleeve side surfaces so that a surgical drill chuck is provided with no sharp edges to prevent snagging, tearing or puncturing surgical latex gloves while handling the chuck during surgical operations.

### CROSS REFERENCE TO RELATED APPLICATION

Applicant claims priority of U.S. Provisional Patent Application No. 60/461,123 filed Apr. 8, 2003.

### FIELD OF THE INVENTION

The present invention relates to drill chucks for holding tool implements, and more particularly, to a drill chuck for use in surgical procedures adapted to prevent snagging, puncturing, or tearing of surgical latex gloves when handling the drill chuck.

### BACKGROUND OF THE INVENTION

The prior art is replete with various types of drill chucks covering a range of shapes, sizes and specified benefits. However, no attention has been paid to drill chucks of the type having a rotatable sleeve with a plurality of sleeve gear teeth for cooperating with a chuck key to open and close jaws for holding a tool implement, in which the chuck has been specifically machined and treated for the unique concerns of surgical procedures. The problem with drill chucks currently being used in surgical procedures is that the chucks have sharp edges at interconnecting surface points that snag and cut through surgical latex gloves. Additionally, the drill chucks currently being used in surgical procedures have rotatable sleeves with sharp sleeve gear teeth, making it difficult for the surgeon to handle the chucks without puncturing the surgeon's latex gloves. Once the surgeon's glove is punctured, he must leave the operating room, rescrub, get new gloves, and then return to surgery. This is time a surgeon typically does not have to waist during a procedure.

For example, U.S. Pat. No. 5,219,174 discloses a drill chuck for a drill to be used particularly for surgical purposes. However, the focus of the invention is on a drill chuck made from a material permeable to x-radiation and does not address the same concerns. No disclosure is provided for specifically rounding the surfaces and edges of the chuck to prevent damaging a latex glove when handling the chuck. Additionally, the sleeve of the chuck is not of the type containing gear teeth for cooperating with a chuck key to operate the chuck.

U.S. Pat. Nos. 4,817,971 and 4,844,488 disclose a chuck actuator device that is placed around the outer periphery of a drill chuck to loosen and tighten the chuck jaws by squeezing the device to hold the chuck sleeve as the body is rotated by the drill. While the invention is constructed and arranged to provide a smooth outer surface to prevent tearing a surgical latex glove, the device is an attachment to a chuck and not a chuck itself. Furthermore, there is no disclosure for treating or finishing the device to ensure smooth surfaces and edges.

U.S. Pat. No. 4,844,070 discloses a changeable scalpel blade and chuck assembly. The chuck sleeve is generally depicted as a cylindrical body having a smooth outer surface. The forward end of the sleeve is chamfered with apparently shape edges, and no gear teeth are provided on the sleeve that may be used for cooperating with a chuck key. No disclosure is provided for rounding any of the surfaces or edges to prevent damaging a surgical latex glove when handling the chuck.

Accordingly, it is an object of the present invention to provide a drill chuck specifically for use in surgical procedures adapted to prevent damaging the surgeon's latex gloves.

It is an object of the present invention to provide a surgical drill chuck that has no sharp edges on the body or jaws of the chuck that may puncture the surgeon's latex gloves through normal use.

It is an object of the present invention to provide a surgical drill chuck that has a rotatable sleeve with rounded sleeve gear teeth for cooperating with a chuck key, wherein the sleeve and sleeve gear teeth are adapted to prevent damaging the surgeon's latex gloves when handling the chuck.

It is an object of the present invention to provide a surgical drill chuck milled and finished to ensure all surfaces and edges are smooth and rounded to prevent snagging, tearing, or puncturing a latex glove when the surgical drill chuck is being handled.

### SUMMARY OF THE INVENTION

The above objectives are accomplished according to the present invention by providing a surgical drill chuck comprising a main body of elongated cylindrical construction having a first distal end and a second distal end. The first distal end has a first radiused corner interconnecting a front end surface and a circumferential side surface, and the second distal end has a second radiused corner interconnecting a rear end surface to the circumferential side surface so that the first and second distal ends are rounded to prevent damage to a surgical latex glove. A plurality of movable jaws are carried by the main body having a projecting end for extending outward from the front end surface of the main body. The projecting end includes a radiused jaw corner interconnecting a jaw end surface and a jaw side surface so that the projecting end is rounded to prevent damage to surgical latex gloves. A sleeve is rotatably carried on the circumferential side surface of the main body and is operatively associated with the jaws for extending and retracting the jaws when the sleeve is rotated. The sleeve has a plurality of gear teeth circumferentially spaced around a first sleeve end for cooperating with a chuck key to rotate the sleeve. Each of the gear teeth including an outer tooth surface having a first tooth surface extending generally in a radial manner outward from the circumferential side surface of the main body, and a radiused tooth corner interconnecting the first tooth surface to a circumferential sleeve side surface so that the outer surfaces of the gear teeth are rounded to prevent damage to a surgical latex glove. Advantageously, the main body, jaws, and sleeve are finished to provide dull rounded edges at the intersections of adjacent surfaces of the main body, jaws, and sleeve. As a result, a surgical drill chuck is provided with smooth rounded surfaces and edges to prevent snagging, tearing or puncturing surgical latex gloves while handling the chuck during surgical operations.

Preferably, the main body, jaws, and sleeve are finished through an abrasive bead blasting process which removes all burs formed during milling of the main body, jaws, and sleeve, and rounds off all edges to prevent damaging a surgical latex glove during handling and use. Additionally, a matte finish is formed on the main body, jaws, and sleeve by the abrasive bead blasting process which results in reduced glare from the chuck when operating under the bright operating room lights.

The above objectives are further accomplished according to the present invention according to a method of providing a surgical drill chuck comprising the steps of providing a main body of elongated cylindrical construction; milling the main body to include radiused corners interconnecting main body end and main body side surfaces; providing a plurality of movable jaws of elongated cylindrical construction carried by the main body; milling the jaws to include radiused corners interconnecting jaw end and jaw side surfaces; providing a sleeve of elongated cylindrical construction carried circumferentially on the main body being operatively associated with the jaws for extending and retracting the jaws when the sleeve is rotated; milling the sleeve to include radiused corners interconnecting sleeve end and sleeve side surfaces; milling the sleeve to include a plurality of gear teeth circumferentially spaced around a first radiused corner of the sleeve so that each of the gear teeth have a rounder outer tooth surface; and, finishing the main body, jaws, and sleeve so that all intersecting surfaces are provided with smooth dull rounded edges to prevent snagging, tearing, or puncturing a surgical latex glove during handling.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a top perspective view of the surgical drill chuck according to the invention;

FIG. 2 shows a bottom perspective view of the surgical drill chuck according to the invention;

FIG. 3 shows a side elevation view of the surgical drill chuck according to the invention;

FIG. 4a shows cross-section of a gear tooth according to the invention;

FIG. 4b shows cross-section of a portion of the sleeve and spacer according to the invention;

FIG. 4c shows a cross-section view of the projecting end of the jaws according to the invention; and,

FIG. 5 shows the surgical drill chucks being finished through a bead blasting process according to the present invention.

### DETAILED DESCRIPTION OF A PREFERRED EMBODIMENT

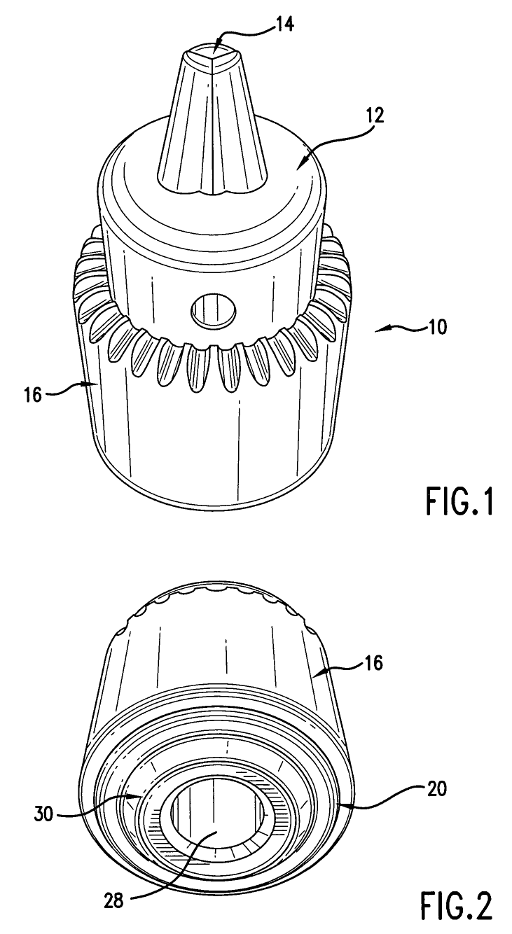

With reference to the drawings, the invention will now be described in more detail. Referring to FIG. 1, a surgical drill chuck, designated generally as 10, is shown for attachment to a surgical drill. Surgical drill chuck 10 is adapted to prevent snagging, tearing or puncturing a surgeon's latex gloves when handling the drill chuck. Chuck 10 includes a main body, designated generally as 12, carrying a plurality of jaws, designated generally as 14, projecting from within main body 12. A sleeve, designated generally as 16 is rotatably carried on said main body and is operatively associated with said jaws to extend and retract the jaw when the sleeve is rotated to hold and change tool implements. Advantageously, all of the surfaces and edges are milled and finished to round off and dull all surfaces and edges to prevent snagging, tearing or puncturing a surgeon's latex gloves, as described in detail below.

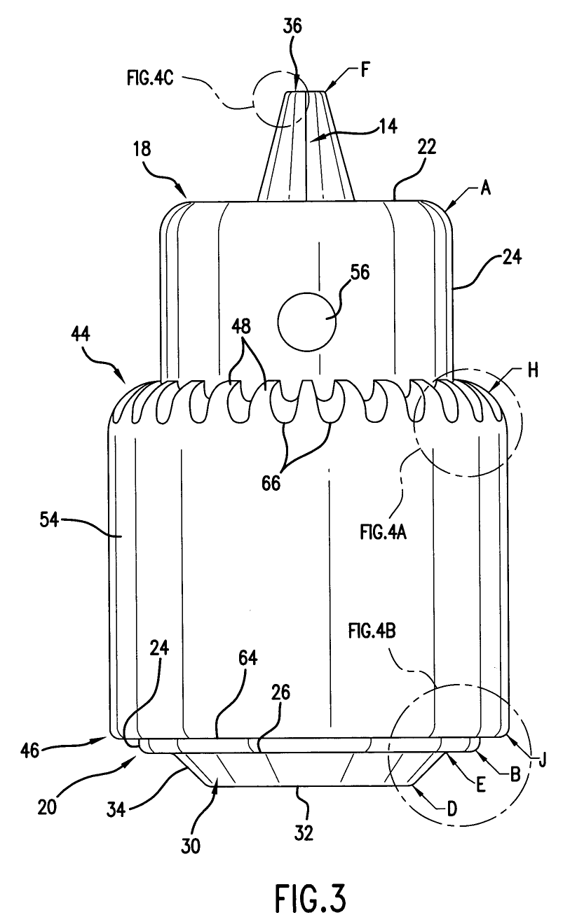

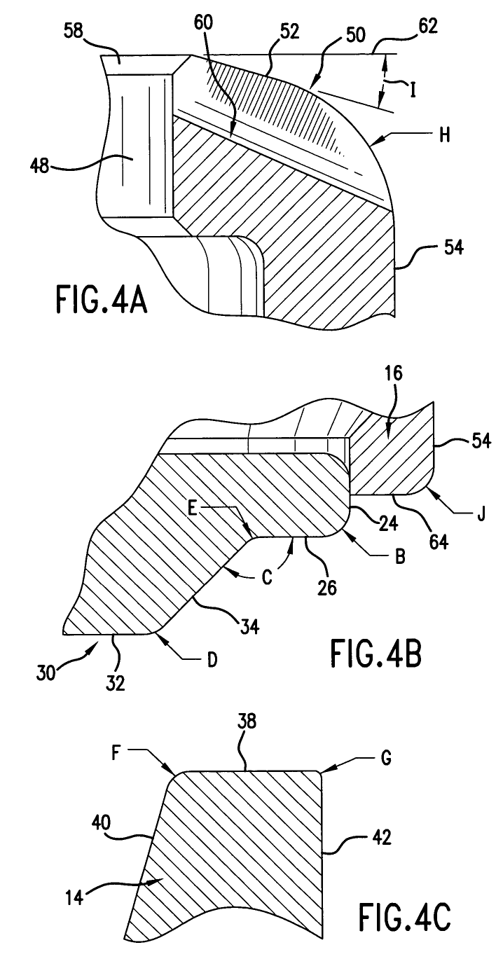

Referring to FIGS. 3 and 4b, main body 12 is of elongated cylindrical construction having a first distal end, designated generally as 18, and a second distal end, designated generally as 20. First distal end 18 is milled to include a first radiused body corner, designated by radius A, interconnecting a front end surface 22 to a circumferential side surface 24 of main body 12. Additionally, as best shown in FIG. 4b, second distal end 20 is milled to include a second radiused body corner, designated by radius B, interconnecting a rear end surface 26 to circumferential side surface 24. Advantageously, as best shown in FIG. 3, first radiused body corner A integrally merges into a coplanar arrangement with front end surface 22 and circumferential side surface 24 so that no sharp edges are provided around the circumference of main body 12 at first distal end 18. As best shown in FIG. 4b, second radiused body corner B also integrally merges into a coplanar arrangement with rear end surface 26 and circumferential side surface 24 so that no sharp edges are provided around the circumference of main body 12 at second distal end 20.

As a result, the first and second distal ends of main body 12 are rounded to prevent damage to a surgical latex glove. Preferably, for a standard size drill chuck having a No. 1 Jacobs Taper Mount, first radiused body corner A has a radius reference of 0.13 inches, and second radiused body corner B has a radius reference of 0.04 inches, which form continuous smooth rounded corners around the circumference of main body 12 at first and second distal ends 18 and 20. Typically in the prior art, first radiused corner A is instead chamfered at a 45° angle producing sharp edges at interconnecting surfaces between the first distal end and the circumferential side surface, which are prone to snagging, tearing and puncturing a surgeons latex gloves. The present invention eliminates this problem associated with the prior art by eliminating the chamfered surfaces commonly used and thereby adapts the chuck for use in surgical procedures.

Referring to FIG. 2, second distal end 20 includes tapered cavity 28 for mounting the chuck to a drill engaging member (not pictured) through a friction fit arrangement. Second distal end 20 also includes a spacer, designated generally as 30, commonly known in the art, extending outwardly from second distal end 20 for spacing main body 12 and sleeve 16 away from a front operating end of a drill. As best shown in FIG. 4b, spacer 30 extends out from rear end surface 26 of main body 12 at an angle, designated generally by angle C, which is preferably approximately a 45° angle. Advantageously, spacer 30 has radiused spacer corners at interconnecting surfaces so that no sharp edges are provided that may damage a latex glove during handling. Spacer 30 is defined as having a spacer end surface 32 that is generally placed against a portion of the front operating end of the drill when tapered cavity 28 completely receives the drill engaging member. Spacer end surface 32 is interconnected with spacer side surface 34 by a radiused corner, designated by radius D. Preferably, radius D has a radius reference of 0.04 inches on the standard size chuck noted above, removing the typical sharp edge present in prior art drill chucks. Spacer side surface 34 further interconnects with main body rear end surface 26 through a radiused corner, designated by radius E. Preferably, radius E has a radius reference of 0.04 inches on the standard size chuck noted above. As a result, all interconnecting surfaces of the main body, including spacer 30 have radiused corners thereby further adapting the chuck for use in surgical procedures by eliminating sharp edges that snag, tear and puncture latex gloves.

Referring to FIGS. 3 and 4c, a plurality of movable jaws 14 are carried by main body 12. The jaws have a projecting end, designated generally as 36, which extends outward from front end surface 22 of main body 12 to hold tool implements such as drill bits and the like. Jaws 14 are preferably formed by milling a cylindrical rod, typically of stainless steel, defined as having a first distal end forming projecting end 36, and a second distal end received within main body 12 being adapted for cooperating with sleeve 16 to extend and retract the jaws when sleeve 16 is rotated, as is commonly known in the art. As best shown in FIG. 4c, the jaws are milled so that projecting end 36 includes a radiused jaw corner, designated by radius F, interconnecting a jaw end surface 38 and a jaw side surface 40. Advantageously, radiused jaw corner F integrally merges into a coplanar arrangement with jaw end surface 38 and jaw side surface 40 so that no edge is created that may snag and damage a latex glove. In a further advantageous embodiment, projecting end 36 includes an additional radiused corner, radius G, interconnecting jaw end surface 38 to a jaw interior side surface 42. Interior side surface 42 is placed in contact with the tool implement intended to be placed in the jaws, and consequently, is in a position for contacting the surgeon's latex gloves when changing implements.

Typically, on prior art chucks not adapted for surgical purposes, projecting end 36 is chamfered which produces sharp edges at the end of the jaws capable of easily cutting through a surgeon's latex gloves. In the preferred embodiment of the invention represented in FIG. 4c, the invention eliminates the chamfered surfaces of the prior art and provides smooth radiused corner F and G at interconnecting jaw surfaces. This eliminates the cutting problems of the prior art and makes the chuck much more user friendly for the surgeon to manipulate without fear of puncturing the latex gloves. Accordingly, by providing radiused corners F and G, projecting end 36 of the jaws are rounded to eliminate any sharp edges to prevent snagging, tearing, or puncturing a surgical latex glove.

A substantial concern with prior art drill chucks is the run-out of the jaws. Typically, the jaws do not extend in an acceptable concentric manner, which produces a wobble, otherwise known as run-out to those skilled in the art, in the tool implement being held in the jaws during drilling. The method used in forming prior art drill chucks holds the chuck in a vice on the outside of the chuck while milling is done to interior side surface 42 of the jaws to attempt to make them concentric. However, holding the chuck from the outside results in inaccurate milling because the chuck is often not properly aligned, leading to undesirable run-out. The present invention solves this problem by mounting the drill chuck on a mounting member inserted into tapered cavity 28 and ensuring that spacer end surface 32 is flat against a solid surface. Next, interior side surface 42 is milled so that the jaws extend to hold a tool implement in a concentric manner within approximately 0.007″ total indicator run-out at 1″ from the main body front end surface 22.

Referring to FIG. 3, sleeve 16 is of elongated cylindrical construction and rotatably carried on circumferential side surface 24 of main body 12. The sleeve is operatively associated with jaws 14 for extending and retracting the jaws when sleeve 16 is rotated. Sleeve 16 is defined as having a first sleeve end, designated generally as 44, and a second sleeve end, designated generally as 46. Sleeve 16 has a plurality of gear teeth 48 circumferentially spaced around first sleeve end 44 for cooperating with complimentary gear teeth of a chuck key to turn sleeve 16 to extend and retract jaws 14. As is commonly known in the art, a chuck key pilot hole 56 is included in main body 12 for receiving a pilot engaging member carried by the chuck key to help maintain the chuck key in position to cooperate with gear teeth 48 of sleeve 16 and apply proper torque to jaws 14 when engaging a tool implement. Advantageously, gear teeth 48 are specifically rounded inward toward main body 12 to eliminate any sharp corners and edges from extending up or out from sleeve 16 that may snag, tear, or puncture a surgeon's latex gloves, as is a common problem with the prior art.

As best shown in FIG. 4a, each of gear teeth 48 include an outer tooth surface, designated generally as 50, having a first tooth surface 52 extending generally in a radial manner outward from circumferential side surface 24 of main body 12. First tooth surface 52 is preferably angled downward at an 18° decline, designated by angle I, from circumferential side surface 24 of main body 12. In a further advantageous embodiment, a chamfered surface 58 is provided to prevent first tooth surface 52 from extending into direct contact with main body 12 in order to prevent burs from forming during rotation of the sleeve that might puncture a latex glove. A radiused tooth corner, designated by radius H, interconnecting first tooth surface 52 to a circumferential sleeve side surface 54 so that the outer surfaces of the gear teeth are rounded to prevent damage to a surgical latex glove. Advantageously, radiused tooth corner H integrally merges into a coplanar arrangement with first tooth surface 52 and circumferential sleeve side surface 54 so that no sharp edges are provided on outer tooth surface 50 of each gear tooth. Preferably, radiused tooth corner H has a radius reference of 0.13 inches for the standard sized chuck noted above. This provides a smooth rounded gear tooth that reduces the chance of the surgeon snagging and damaging a latex glove. Referring to FIG. 4a, tooth groove, designated generally as 60 is positioned 0.088 inches vertically beneath horizontal plane 62 and extends downward from horizontal plane 62 preferably at a 27° decline, which provides sufficient depth to the teeth to ensure proper engagement with the chuck key.

Referring to FIG. 4b, second sleeve end 46 also includes a radiused sleeve corner, designated by radius J, interconnecting circumferential sleeve side surface 54 to a bottom sleeve surface 64. Advantageously, radiused sleeve corner J integrally merges into a coplanar arrangement with circumferential sleeve side surface 54 and bottom sleeve surface 64 so that no sharp edge is provided on the second sleeve end.

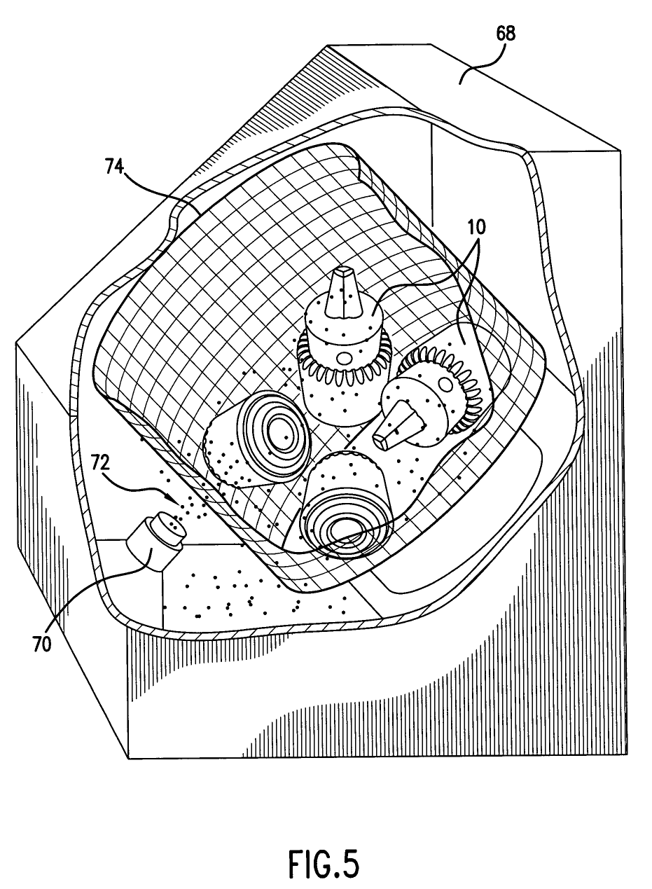

Referring to FIG. 5, drill chucks 10 are finished through a bead blasting processes, to further round off all the surfaces and edges of jaws 14, main body 12, and sleeve 16 to remove any burs formed during milling and round off and dull all interconnecting surfaces so that the drill chuck is smooth to the touch to prevent snagging, tearing or puncturing a surgical latex glove. The process ensures that the edges of intersecting tooth surfaces, such as inner teeth edges 66 (FIG. 3), are significantly dulled down and rounded to provide a radiused corner that will not damage a latex glove. As a result, a drill chuck is provided with smooth rounded surfaces adapted for use in surgical procedures by preventing snagging, puncturing, and tearing of surgical latex gloves during surgical operations requiring the use of a drill.

As shown in FIG. 5, a bead blasting unit, designated generally as 68, is shown having a spray nozzle 70 for spraying glass beads 72 at extremely high pressure into a rotating basket 74 holding a plurality of surgical drill chucks 10. Preferably, the chucks are finished by bead blasting for a period of 10 minutes, or more as necessary, in the rotating basket to ensure that every side of the chuck is treated to be smooth, dull, and rounded. Advantageously, the bead blasting treatment results in a matte finish on the chuck, which eliminates glare from the bright lights in the operating room so that the surgeon can better see the area surrounding the chuck. Additionally, the chuck may be polished and chemically treated to produce the same smooth rounded edges and surfaces.

While a preferred embodiment of the invention has been described using specific terms, angles, and radiuses, such description is for illustrative purposes only, and it is to be understood that changes and variations may be made without departing from the spirit or scope of the following claims.

What is claimed is:

1. A surgical drill chuck comprising:
a main body of elongated cylindrical construction having a first distal end and a second distal end;
said first distal end having a first radiused body corner interconnecting a front end surface and a circumferential side surface, and said second distal end having a second radisued body corner interconnecting a rear end surface to said circumferential side surface so that said first and second distal ends are rounded to prevent damage to a surgical latex glove;
a plurality of movable jaws carried by said main body having a projecting end for extending outward from said front end surface of said main body;
said projecting end including a radiused jaw corner interconnecting a jaw end surface and a jaw side surface so that said projecting end is rounded to prevent damage to surgical latex glove;
a sleeve rotatably carried on said circumferential side surface of said main body operatively associated with said jaws for extending and retracting said jaws when said sleeve is rotated, said sleeve having a plurality of gear teeth circumferentially spaced around a first sleeve end for cooperating with a chuck key to rotate said sleeve;
each of said gear teeth including an outer tooth surface having a first tooth surface extending generally in a radial manner outward from said circumferential side surface of said main body, and a radiused tooth corner interconnecting said first tooth surface to a circumferential sleeve side surface so that the outer surfaces of said gear teeth are rounded to prevent damage to a surgical latex glove; and
said main body, jaws, and sleeve being finished to provide dull rounded edges at the intersections of adjacent surfaces;
whereby a surgical drill chuck is provided with smooth rounded surfaces and edges to prevent snagging, tearing or puncturing surgical latex gloves while handling the chuck during surgical operations.

2. The surgical drill chuck of claim 1 wherein said first radiused body corner integrally merges into a coplanar arrangement with said front end surface and said circumferential side surface so that no sharp edges are provided around the circumference of said main body at said first distal end.

3. The surgical drill chuck of claim 1 wherein said second radiused body corner integrally merges into a coplanar arrangement with said rear end surface and said circumferential side surface so that no sharp edges are provided around the circumference of said main body at said second distal end.

4. The surgical drill chuck of claim 1 wherein said radiused jaw corner integrally merges into a coplanar arrangement with said jaw end surface and said jaw side surface so that no sharp edges are provided on said projecting end.

5. The surgical drill chuck of claim 1 wherein said radiused tooth corner integrally merges into a coplanar arrangement with said first tooth surface and said circumferential sleeve side surface so that no sharp edges are provided on said outer tooth surface of said gear teeth.

6. The surgical drill chuck of claim 1 wherein said main body, jaws, and sleeve are finished through an abrasive bead blasting process which removes all burs formed during milling and rounds off all edges to prevent damaging a surgical latex glove during handling and use.

7. The surgical drill chuck of claim 6 wherein said main body, jaws, and sleeve have a matte finish formed by said abrasive bead blasting process to reduce glare.

8. The surgical drill chuck of claim 1 wherein said sleeve includes a second sleeve end; said second sleeve end including a radiused sleeve corner interconnecting said circumferential sleeve side surface to a bottom sleeve surface so that no sharp edge is provided on said sleeve.

9. The surgical drill chuck of claim 8 wherein said radiused sleeve corner integrally merges into a coplanar arrangement with said circumferential sleeve side surface and said bottom sleeve surface so that no sharp edge is provided on said second sleeve end.

10. The surgical drill chuck of claim 1 including a spacer carried at said second distal end of said main body for spacing said main body and sleeve away from a front operating end of a drill; said spacer having radiused spacer corners so that no sharp edges are provided that may damage a latex glove during handling.

11. A surgical drill chuck comprising:
a main body of elongated cylindrical construction having intersecting main body end and main body side surfaces;
a plurality of movable jaws of elongated cylindrical construction carried by said main body having intersecting jaw end and jaw side surfaces;
a sleeve of elongated cylindrical construction carried circumferentially on said main body being operatively associated with said jaws for extending and retracting said jaws when said sleeve is rotated, said sleeve having intersecting sleeve end and sleeve side surfaces; and,
radiused corners provided at the intersection of said main body end and main body side surfaces, said jaw end and jaw side surfaces, and said sleeve end and sleeve side surfaces so that a surgical drill chuck is provided with no sharp edges at intersecting end and side surfaces to prevent snagging, tearing or puncturing surgical latex gloves while handling the chuck during surgical operations.

12. The surgical drill chuck of claim 1 wherein said main body, jaws, and sleeve are finished so that all intersecting surface are provided with smooth dull rounded edges.

13. The surgical drill chuck of claim 1 wherein said main body, jaws, and sleeve are finished through an abrasive bead blasting process which removes all burs formed during milling and rounds off and dulls all edges to prevent damaging a surgical latex glove during handling and use.

14. The surgical drill chuck of claim 13 wherein said main body, jaws, and sleeve have a matte finish formed by said abrasive bead blasting process to reduce glare.

15. A method of providing a surgical drill chuck comprising the steps of:
providing a main body of elongated cylindrical construction;
milling said main body to include radiused corners interconnecting main body end and main body side surfaces;
providing a plurality of movable jaws of elongated cylindrical construction carried by said main body;
milling said jaws to include radiused corners interconnecting jaw end and jaw side surfaces;
providing a sleeve of elongated cylindrical construction carried circumferentially on said main body being operatively associated with said jaws for extending and retracting said jaws when said sleeve is rotated;
milling said sleeve to include radiused corners interconnecting sleeve end and sleeve side surfaces;
milling said sleeve to include a plurality of gear teeth circumferentially spaced around a first radiused corner of said sleeve so that each of said gear teeth have a rounder outer tooth surface; and,
finishing said main body, jaws, and sleeve so that all intersecting surfaces of said main body, jaws, and sleeve are provided with smooth dull rounded edges to prevent snagging, tearing, or puncturing a surgical latex glove during handling.

16. The method of claim 15 including the step of finishing said main body, jaws, and sleeve through an abrasive bead blasting process to remove all burs formed during milling and rounds off and dulls all edges.

17. The method of claim 16 including the step of bead blasting said main body, jaws, and sleeve to provide a matte finish that reduces glare on the main body, jaws, and sleeve under bright operating room lights.
